(19) United States
(12) Patent Application Publication
(10) Pub. No.: US 2025/0341120 A1
(43) Pub. Date: Nov. 6, 2025

(54) RETAIL SECURITY ASSEMBLY

(71) Applicant: Sekura Global IP LLP, Colchester (GB)

(72) Inventors: Timothy PRYCE-HALL, Colchester (GB); Edward PRICE, Colchester (GB)

(73) Assignee: Sekura Global IP LLP, Colchester (GB)

(21) Appl. No.: 18/870,679

(22) PCT Filed: Jun. 1, 2023
(86) PCT No.: PCT/GB2023/051443

§ 371 Date: Dec. 1, 2024

(30) Foreign Application Priority Data
Jun. 1, 2022 (GB) 2208092.3

(51) Int. Cl. E05B 73/00

(52) U.S. Cl. CPC E05B 73/0023

(57) ABSTRACT

A security assembly comprises a housing having side panels extending between a front panel and a rear panel, the housing defining a space for receiving an item, and edges of the front panel, rear panel and two side panels defining an opening of the housing; an EAS sensor; and a lockable security element having a first part comprising a latch mechanism and a second part comprising a pin, the first part being secured to the housing in a fixed position relative adjacent the opening of the housing, and the second part being moveable between an open position, in which an item is insertable into the housing, and a closed position, in which the second part obstructs the opening and a part of said item is clamped between the first and second parts of the lockable security element. The pin is moveable to extend through a portion of said item clamped between the first and second parts, and the latch mechanism is configured to releasably retain the tip of the pin.

### FIELD OF THE INVENTION

The present invention relates to security assemblies including a lockable security element and methods of providing a security assembly for an item. In particular, the present invention relates to a security assembly including an electronic article surveillance (EAS) sensor and a protective case or housing and a method of protecting an item in a retail environment.

### BACKGROUND TO THE INVENTION

A number of electronic article surveillance (EAS) systems are well known and are used in areas such as retail stores to deter or prevent the theft of articles or items of merchandise from the area.

EAS systems include an EAS tag or sensor that is attached to the article, an EAS antenna or detector that it typically positioned at or near an exit of the area, and a detacher or deactivator for removing or deactivating the EAS tag when the article is purchased or is otherwise being removed from the area permissibly or legally.

An EAS system may include one or more technologies selected from magnetic (EM) systems, acousto-magnetic (AM) systems and radio-frequency (RF) systems. Each of these systems have advantages and disadvantages regarding cost, reliability, ease of detection and size.

One known EAS tag is commonly referred to as a hard tag and includes an acousto-magnetic sensor in a hard, or semi-rigid, plastic body. Such hard tags are typically physically or mechanically attached to an article by means of a pin, cable or lanyard. When the article is purchased, the tag is detached from the article by a detacher located at the point of sale.

If the tag is not removed and the article is removed from an area, such as a retail store, the sensor in the tag will emit a signal that is detected by the antenna that is located near the exit of the area. The antenna will typically emit an audible alarm to alert security personnel that an item is being removed impermissibly or illegally, with the tag still attached to the article.

In some cases a security tag may be applied directly to a part of an item, for example to an item of clothing or an accessory such as a bag. In other circumstances, however, the security tag is attached to the packaging of the item. In these cases, one known method to circumvent the security tag is to open the packaging in the store and remove the item from the packaging. The item can then be removed from the store, while the packaging remains in the store.

It is known to place some small, high value items, such as razors, perfume and the like, in safers or keepers. These are lockable plastic containers that surround the item and include an integral hard tag or EAS tag. When an item is purchased, the safer is unlocked and opened to remove the item. The safer may then be reused.

There are, however, a number of disadvantages of these safers. Firstly, they are very bulky. While a retail business may utilise several different sizes of safers, to reduce the number of different sizes of safers that must be stocked, a single size of safer may be used to encase and protect many different sizes and shapes of product. In many cases, therefore, the dimensions of the safer can be significantly greater than the dimensions of the product contained within the safer. This can result is wasted space on a retail shelf or other retail display. Furthermore, when the safers are not in use they are bulky to store. Secondly, the safers also fully surround the item in its packaging. This prevents someone opening the packaging to remove the item, with the packaging remaining within the store. This can, however, make the product difficult to see, which may be important if a customer needs to read information provided on the packaging. Thirdly, prior art safers comprise a plastic box or shell defining an interior space in which the item may be placed and a lockable lid. The lid is arranged to be unlocked using a suitable detacher allowing the item to be removed from the safer when the item is purchased. This, however, requires the use of specialist detachers for these safers, which must be available at every checkout or point of sale terminal.

It is an object of the present invention to provide an improved security tag that overcomes at least one problem associated with the prior art whether referred to herein or otherwise.

### SUMMARY OF THE INVENTION

A first aspect of the invention provides a security assembly comprising:
a housing including a base panel, a front panel, a rear panel and two side panels, each side panel extending between the front panel and the rear panel, the housing defining a space for receiving an item, and edges of the front panel, rear panel and two side panels defining an opening of the housing;
a lockable security element having a first part comprising a latch mechanism and a second part comprising a pin having a tip, in use, a part of said item being clamped between the first and second parts of the lockable security element; and
an EAS sensor,
wherein, the pin is moveable from a first position in which the tip of the pin is within the second part to a second position in which the pin extends from the second part into the first part so as to, in use, extend through a portion of said item clamped between the first and second parts, and the latch mechanism being configured to releasably retain the tip of the pin when the pin is in the second position, and
wherein a part of the housing is disposed between the first and second parts of the lockable security element, said part of the housing including a hole aligned with the latch mechanism through which the pin extends when the pin is in the second position.

In preferred embodiments the first part of the security element is secured to the housing in a fixed position relative to the housing and adjacent the opening of the housing, and the second part of the security element is moveable relative to the first part between an open position, in which an item is insertable into the housing, and a closed position, in which the second part obstructs the opening and, wherein, in the closed position the pin is moveable from the first position to the second position.

In preferred embodiments the first part of the lockable security element is permanently secured to the housing.

In some embodiments the first part of the lockable security element is secured to the rear panel of the housing. The first part of the lockable security element is preferably secured to a surface of the rear panel such that a part of the rear panel is disposed between the first and second parts of the lockable security element. The part of the rear panel disposed between the first and second parts of the lockable security element preferably includes the hole aligned with the latch mechanism and through which the pin extends when the pin is in the second position.

In other embodiments the housing comprises a rail extending between the side panels, and the first part of the lockable security element is secured to the rail. The first part of the lockable security element is preferably secured to a surface of the rail such that a part of the rail is disposed between the first and second parts of the lockable security element. The part of the rail disposed between the first and second parts of the lockable security element preferably includes the hole aligned with the latch mechanism and through which the pin extends when the pin is in the second position.

In preferred embodiments the first and second parts of the lockable security element are hingedly connected together.

In preferred embodiments the latch mechanism is magnetically releasable.

In some embodiments the EAS sensor is housed in the first part of the lockable security element. In other embodiments the EAS sensor may be housed in the second part of the lockable security element or in the housing. In some embodiments the security assembly further comprises a second EAS sensor, and the EAS sensors are both disposed in the first part of the lockable security element.

In some embodiments the rear panel comprises a first lateral portion and a second lateral portion and there is a gap between the first and second lateral portions defined by a distance between inner edges of the lateral portions. In some embodiments the front panel comprises a first lateral portion and a second lateral portion and there is a gap between the first and second lateral portions defined by a distance between inner edges of the lateral portions.

The housing is preferably made of a transparent or translucent polymeric material.

The housing is preferably rigid.

A second aspect of the invention provides an assembly comprising:
a security assembly according to the first aspect of the invention; and
a hang tab box seated in the housing of the security assembly, a header of the hang tab box disposed between the first and second parts of the lockable security element.

In preferred embodiments the assembly comprises:
a housing including a base panel, a front panel, a rear panel and two side panels, each side panel extending between the front panel and the rear panel, and the rear panel including a hole;
a hang tab box seated in the housing with a header of the hang tab box disposed adjacent the rear panel of the housing;
a lockable security element having a first part comprising a latch mechanism and a second part comprising a pin having a tip, the header of the hang tab box and the rear panel of the housing disposed between the first and second parts of the lockable security element, the pin extending through the header and the hole in the rear panel, and the latch mechanism releasably retaining the tip of the pin; and
an EAS sensor.

A third aspect of the invention provides a method of securing a security assembly to a hang tab box, the security assembly being according to the first aspect of the invention, and the method comprising:
seating the hang tab box in the housing of the security assembly; and
moving the pin from the first position into the second position so that the pin extends through the header and the hole of the housing and is engaged in the latch mechanism.

In some embodiments the first part of the security element is secured to the housing in a fixed position relative to the housing and adjacent the opening of the housing, and the second part of the security element is moveable relative to the first part between an open position and a closed position, and in the closed position the pin is moveable from the first position to the second position. In these embodiments the method preferably comprises seating the hang tab box in the housing with the second part of the lockable security element in the open position, and moving the second part of the lockable security element into the closed position so that a part of a header of the hang tab box is disposed between the first and second parts of the lockable security element before moving the pin from the first position into the second position.

In some embodiments the hang tab box is seated in the housing such that the header is disposed adjacent the rear panel of the housing, and the second part of the lockable security element is moved into the closed position so that a part of the header and a part of the rear panel are clamped between the first and second parts of the lockable security element.

In other embodiments, in which the housing comprises a rail extending between the side panels, the hang tab box is seated in the housing such that the header is disposed adjacent the rail. The second part of the lockable security element may then be moved into the closed position so that a part of the header and a part of the rail are clamped between the first and second parts of the lockable security element.

Preferred and/or optional features of each aspect and embodiment described above may also be used, alone or in appropriate combination, in the other aspects and embodiments also.

### BRIEF DESCRIPTION OF THE DRAWINGS

The invention will now be further described by way of example only and with reference to the accompanying drawings, in which like reference signs are used for like features, and in which:

FIG. 1 is a perspective view of a security assembly according to a first preferred embodiment of the present invention, including a housing and a lockable security element;

FIG. 2 is a side view of the security assembly of FIG. 1;

FIG. 3 is further perspective view of the security assembly of FIG. 1;

FIG. 4 is a cross-sectional view along the line IV-IV of FIG. 3;

FIG. 5 is a perspective view of a security assembly according to a second preferred embodiment of the present invention, including a housing and a lockable security element;

FIG. 6 is a side view of the security assembly of FIG. 4;

FIG. 7 is further perspective view of the security assembly of FIG. 4;

FIG. 8 is a cross-sectional view along the line VIII-VIII of FIG. 7;

FIG. 9 shows the lockable security element of the security assemblies of both

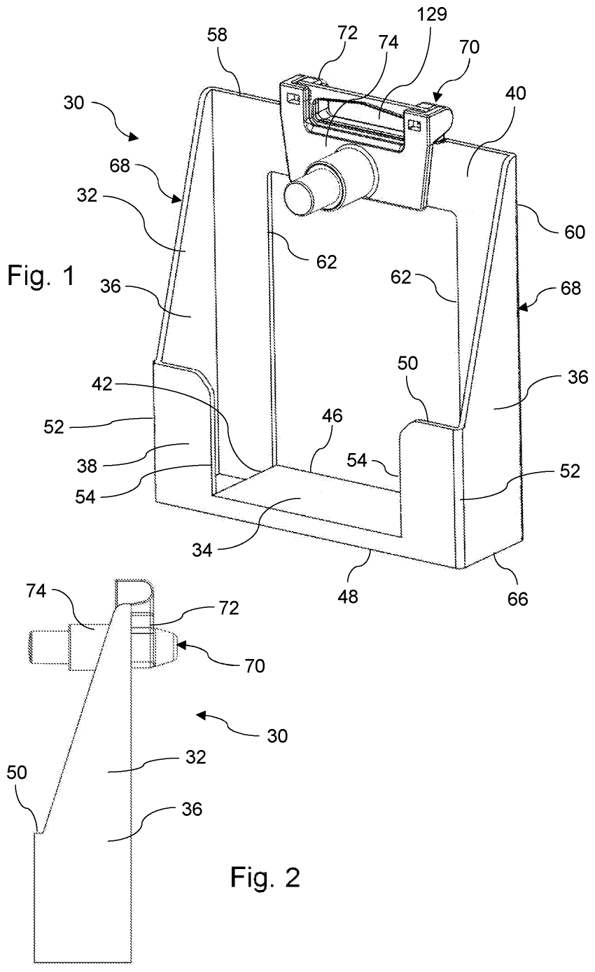

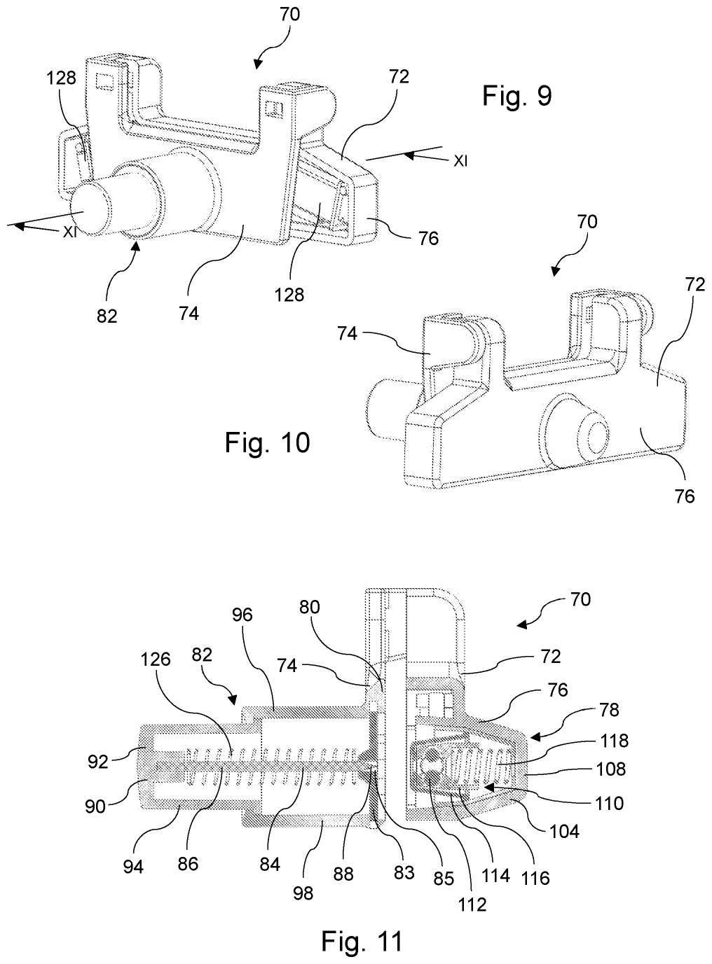

FIG. 1 and FIG. 5, from a first side and showing the lockable security element in an unlocked configuration;

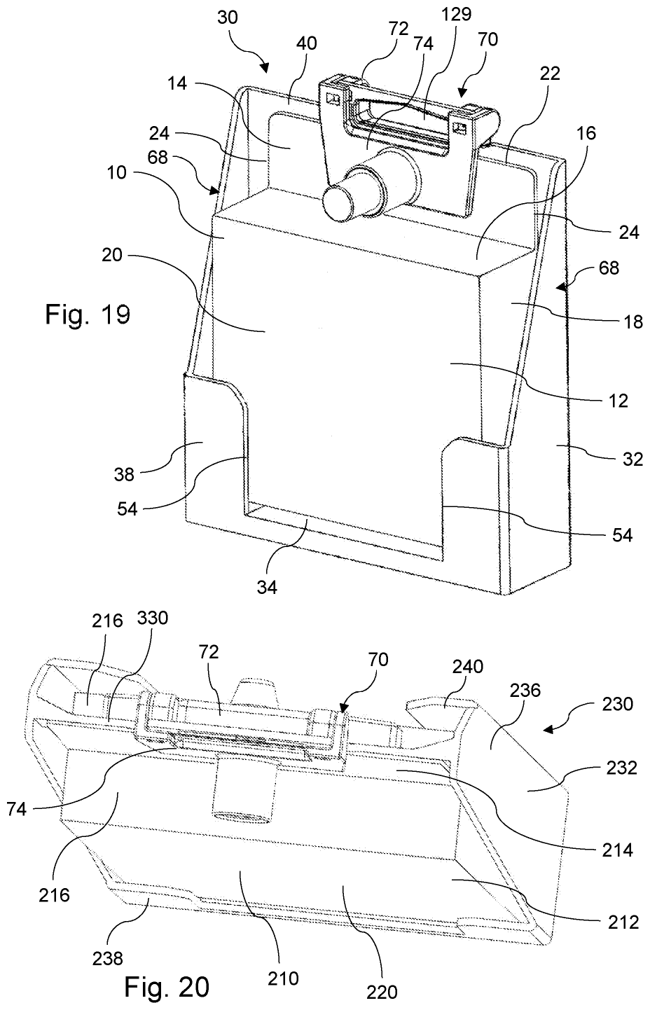

FIG. 10 shows the lockable security element of FIG. 9 from a second side and in the unlocked configuration;

FIG. 11 is a cross-sectional view of the lockable security element of FIG. 9 along the line XI-XI;

FIG. 12 shows the lockable security element of FIG. 9 from the first side and in a locked configuration;

FIG. 13 shows the lockable security element of FIG. 12 from the second side and in the locked configuration;

FIG. 14 is a cross-sectional view of the lockable security element of FIG. 12 along the line XIV-XIV;

FIG. 15 shows a first part of the lockable security element of FIG. 9;

FIG. 16 shows a second part of the lockable security element of FIG. 9;

FIG. 17 shows the housing of FIG. 1 and the first part of the lockable security element of FIG. 15;

FIG. 18 shows the housing of FIG. 5 and the first part of the lockable security element of FIG. 15;

FIG. 19 shows the security assembly of FIG. 1 ready to be attached to an item in the form of a hang tab box; and

FIG. 20 shows the security assembly of FIG. 5 attached to an item in the form of a hang tab box.

### DESCRIPTION OF THE PREFERRED EMBODIMENTS

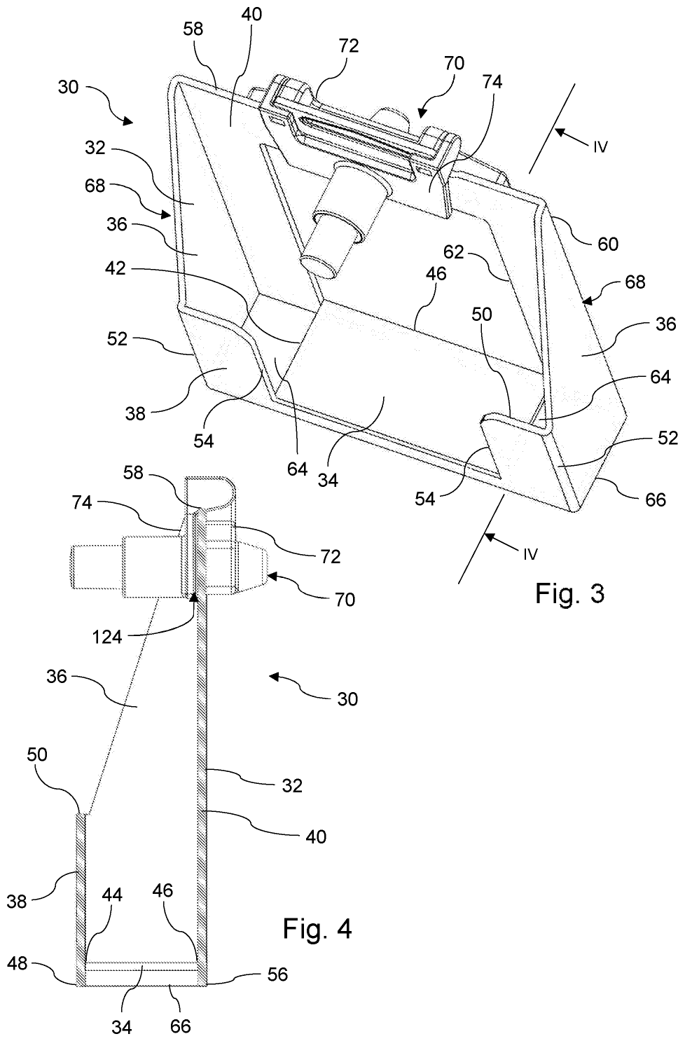

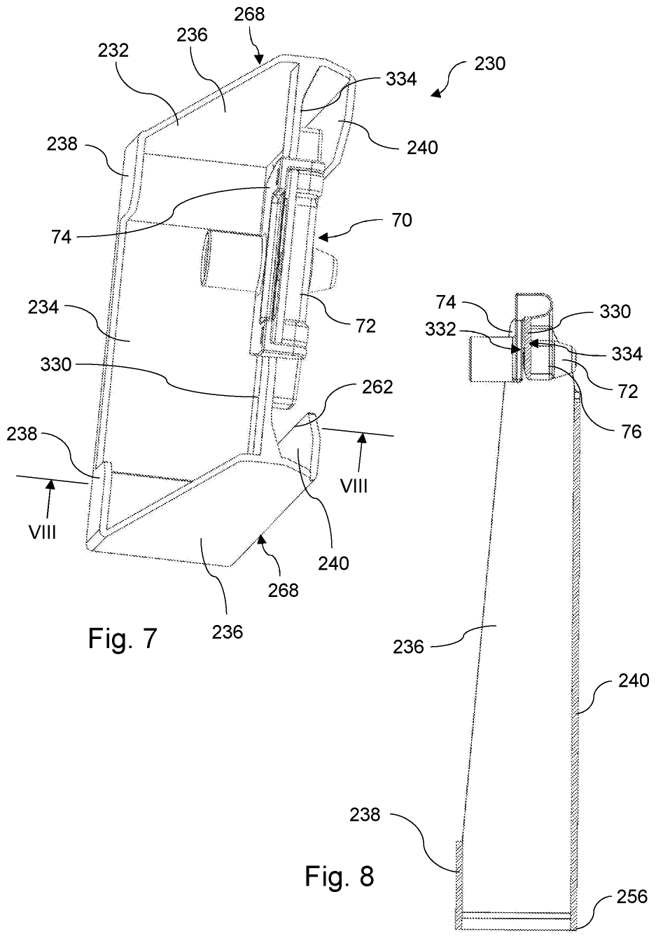

A security assembly 30 according to a first preferred embodiment of the present invention is illustrated in FIGS. 1 to 4. The security assembly 30 is configured to attach to an item in a retail environment to prevent or deter theft of that item. The security assembly 30 is arranged to be attached to packaging of the item when the packaging is a hang tab box.

Referring briefly to FIG. 19, a hang tab box 10 comprises a box 12, which is usually in the form of a tuck end box or tuck top box, having an internal volume for holding the contents of the packaging. A header or hang tab 14 extends from the box 12 and may be provided with an aperture or hang hole (not shown) for hanging the packaging on a suitable display unit, such as a hook or rail, in a retail store. In the illustrated example the header 14 is integrally formed with the box 12.

The box 12 includes opposite bottom and top panels (only top panel 16 is shown), opposite side panels 18 and opposite front and rear panels (only front panel 20 is shown). The header or hang tab 14 usually extends from the upper flap or top panel 16 of the box 12 to allow the packaging to be suspended or hung from a display unit. A height of the header 14 is defined as the distance between the top panel 16 of the box 12 and an upper edge 22 of the header 14. A width of the header 14 is defined as the distance between opposite lateral edges 24 of the header 14.

The hang tab box 10 is preferably made at least partially from a cardboard or paperboard material. The hang tab box 10 may include a transparent or translucent display window made from a suitable polymeric material. This display window may allow a customer to view the contents of the hang tab box 10.

Due to the construction of the hang tab box 10, the internal volume of the box 12 is generally accessible by opening one or more of the top panel 16, bottom panel or one of the side panels 18. As such, once the item has been purchased, a customer may open the hang tab box 10 by disengaging or tearing one of the top panel 16, bottom panel or one of the side panels 18 and removing the item from its packaging.

Referring back to FIGS. 1 to 4, the security assembly 30 comprises a casing or housing 32 configured, in use, to surround at least a part of the box 12 of a hang tab box 10, and a lockable security element 70 configured, in use, to be secured to a header 14 of a hang tab box 10.

The housing 32 comprises a base panel 34, two side panels 36, a front panel 38 and a rear panel 40. In this embodiment the base panel 34 is generally rectangular having two opposite side edges 42 and opposite front and rear edges 44, 46. The front panel 38 has a lower edge 48, an upper edge 50 and two side edges 52. In this embodiment the front panel 38 is generally U-shaped; the lower edge 48 is straight and a distance between the lower edge 48 and the upper edge 50 in a central portion of the front panel 38 is smaller than a distance between the lower edge 48 and the upper edge 50 in lateral portions of the front panel 38, between the central portion and each of the side edges 52. In this way, each of the lateral portions has an inner edge 54, and there is a gap between the opposing inner edges 54.

The rear panel 40 has a lower edge 56, an upper edge 58 and two side edges 60. In this embodiment the rear panel 40 comprises an upper portion that extends from the upper edge 58 between the side edges 60. Two lateral portions extend from the upper portion downwardly to the lower edge 56. In this way, each of the lateral portions has an inner edge 62, and there is a gap between the opposing inner edges 62. In preferred embodiments the distance between the inner edges 54 of the front panel 38 is the same as the distance between the inner edges 62 of the rear panel 40.

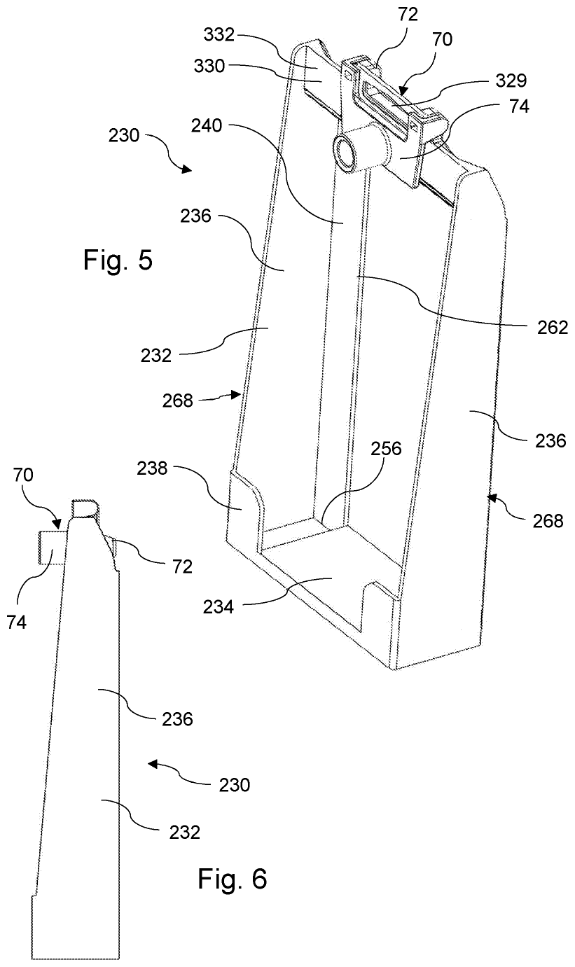

A distance between the side edges 42 of the base panel 34 may be substantially equal to the distance between the inner edges 54 of the front panel and the distance between the inner edges 62 of the rear panel 40. In this way, there may be a gap between each of the side edges 42 of the base panel 34 and the respective side panel 36 of the housing 32. As shown most clearly in FIG. 3, an aperture 64 is, therefore, defined between each side edge 42, the respective side panel 36 and the lateral portions of the front and rear panels 38, 40.

In this example, a maximum distance between the lower edge 48 and the upper edge 50 of the front panel 38, i.e. a height of the front panel 38, is less than a maximum distance between the lower edge 56 and the upper edge 58 of the rear panel 40, i.e. a height of the rear panel 40. In this example the maximum height of the front panel 38 is less than half the maximum height of the rear panel 40.

The side panels 36 of the housing 32 extend between the front and rear panels 38, 40. In particular, each side panel 36 extends between a respective side edge 52 of the front panel 38 and a respective side edge 60 of the rear panel 40, such that a first side edge of the side panel 36 is coincident with the side edge 52 of the front panel 38 and a second side edge of the side panel 36 is coincident with the side edge 60 of the rear panel 40. A lower edge 66 of each of the side panels 36 is preferably aligned with or continuous with the lower edges 48, 56 of the front and rear panels 38, 40. In this embodiment, because the height of the front panel 38 at each of its side edges 52 is less than a height of the rear panel 40 at each of its side edges 60, each of the side panels 36 has a trapezium shape.

The upper edge 58 of the rear panel 40, the upper edge 50 of the front panel 38 and upper edges of the side panels 36 together define an opening of the housing 32. The opening provides access to a space defined by the housing 32, and permits insertion of an object into the housing 32.

Each of the side panels 36, together with the respective lateral portion of the front panel 38 and lateral portion of the rear panel 40 extending from the side panel 36, forms a lateral guard portion 68 of the housing 32.

Referring again to FIG. 19, in use, the base panel 34 extends over a bottom panel of a hang tab box 10 retained in the housing 32. Each of the lateral guard portions 68 extends over a respective side panel 18 of the hang tab box 10 and, in particular, restricts access to edges of the box 12 defined between each of the side panels 18 and the front panel 20 or rear panel. In this way the housing 32 restricts access to the hang tab box 10 such that it is difficult or impossible for a person to open the box 12 to remove the item held within the box 12.

Returning to FIGS. 1 to 4, in this embodiment, the lockable security element 70 is attached to the upper portion of the rear panel 40 of the housing 32. The lockable security element 70 comprises a first part 72 secured to the housing 32 in a fixed position and a second part 74 that is moveable with respect to the first part 72. In preferred embodiments the first part 72 of the lockable security element 70 is permanently secured to the housing 32.

The first part 72 of the lockable security element 70 comprises a casing 76 and a latch assembly 78. The second part 74 of the lockable security element 70 comprises a clamping plate 80 and a pin assembly 82. These features of the lockable security element 70 are more clearly shown in FIGS. 9 to 16.

The pin assembly 82 comprises a pin 84 having a shaft 86 and a tip 88. A cap 90 is attached to the shaft 86 at its end furthest from the tip 88. In this example the cap 90 comprises a disc element 92 that extends radially outwardly from the shaft 86. A sleeve 94 is connected to the cap 90 and a tubular side wall of the sleeve 94 extends along and around the shaft 86 of the pin 84 in a direction towards the tip 88. A lip extends radially outwardly from the free end of the side wall of the sleeve 94 furthest from the cap 90. The cap 90 and sleeve 94 together form a button assembly.

The pin assembly 82 further comprises a pin housing 96. The pin housing 96 comprises a tubular side wall 98 that extends from the clamping plate 80. A lip extends inwardly at an end of the tubular side wall 98 furthest from the clamping plate 80. The lip defines an aperture through which the sleeve 94 extends. A diameter of the aperture and an outer diameter of the side wall of the sleeve 94 are such that there is a sliding fit of the sleeve 94 through the aperture. A radially outer diameter of the lip of the sleeve 94 is larger than the diameter of the aperture, and the lip therefore retains the free end of the sleeve 94 within the pin housing 96.

The clamping plate 80 includes an aperture 81 which is aligned with the pin assembly 82. In this embodiment, and as shown most clearly in FIG. 11, a guide disc 83 is attached to the clamping plate 80 and aligned with the aperture 81. The guide disc 83 includes a hole 85 that is aligned with an axis of the pin 84. It will be understood that in other embodiments the hole may be formed directly in the clamping plate.

Each latch assembly 78 comprises a latch housing 104. The latch housing 104 is formed by a part of the casing 76 and includes a frustoconical or tapered side wall and an end wall 108. A latch mechanism 110 is disposed within the latch housing 104. The latch mechanism 110 is configured to releasably retain the pin 84.

Suitable latch mechanisms 110 are known in the art and will not be described in detail; however, one example of a latch mechanism 110 shown in this example includes a plurality of ball bearings or spheres 112 retained in a volume defined by a frustoconical cup element 114. The cup element 114 is positioned in the latch housing 104 such that a diameter of the cup element 114 increases in a direction towards the end wall 108. The latch mechanism 110 further comprises an actuating element 116 received within the cup element 114, and with which the spheres 112 are engaged, and a biasing member in the form of a spring 118 that acts on the actuating element 116 to urge the actuating element 116 and therefore the spheres 112 in a direction away from the end wall 108. At least the actuating element 116 is preferably made of a suitable metal material.

FIG. 17 shows the first part 72 of the lockable security element 70 attached to the rear panel 40 of the housing 32 of this embodiment. The casing 76 of the first part 72 of the lockable security element 70 is secured to a rear side of the rear panel 40 proximate or adjacent the upper edge 58 of the rear panel 40. The rear panel 40 includes an aperture or hole 41 which is aligned with the latch assembly 78 housed within the first part 72.

In this embodiment the second part 74 of the lockable security element 70 further comprises a pair of pivot pins or pivot lugs 120 that engage with corresponding pivot recesses 122 of the first part 72 of the lockable security element 70. Engagement of the pivot lugs 120 in the pivot recesses 122 enables the second part 74 of the lockable security element 70 to rotate about an axis of the pivot lugs 120 between an open position and a closed position. In this embodiment the axis of rotation of the pivot lugs 120 is above the upper edge 58 of the rear panel 40. In the open position, a distance or gap 124 between the clamping plate 80 and the rear panel 40 of the housing 32 is greater than when the first and second parts 72, 74 are in the closed position. Furthermore, when the first and second parts 72, 74 are in the closed position, the hole 85 in the clamping plate 80 or in the second part 74 is aligned with the hole 41 in the rear panel 40 and the pin 84 is aligned with the latch mechanism 110, allowing the lockable security element 70 to move between a disengaged or released configuration, shown in FIGS. 9 to 11, and an engaged or locked configuration, shown in FIGS. 12 to 14.

In the released configuration the pin 84 is in a first position in which the tip 88 of the pin 84 is housed within the pin housing 96 and the sleeve 94 protrudes from the housing 96 in a direction away from the clamping plate 80. A biasing member, which in this embodiment is in the form of a spring 126, is disposed within the housing 96 and acts on the cap 90 to urge the pin 84 into this first position. The lip of the sleeve 94 is in engagement with the housing 96 to limit movement of the pin 84 in a direction away from the clamping plate 80.

To move the lockable security element 70 from the released configuration to the locked configuration a user presses on the cap 90 in a direction towards the clamping plate 80. This pushes the sleeve 94 into the housing 96 against the force of the spring 126. This also causes the pin 84 to protrude from or extend through the hole 85 in the clamping plate 80 into a second position.

In the second position the pin 84 extends across the gap 124 between the clamping plate 80 and the rear panel 40 of the housing and through the hole 41 in the rear panel 40, and the tip 88 of the pin 84 enters the latch housing 104. In the second position the cap 90 may be in contact with the end of the tubular side wall 98 of the pin housing 96 furthest from the clamping plate 80.

The tip 88 of the pin 84 engages with the latch mechanism 110. In this example, the tip 88 of the pin 84 extends between the ball bearings 112 so that the ball bearings 112 surround the pin 84. The latch mechanism 110 is biased into a first, gripping position, in which the ball bearings 112 are urged towards the pin 84, by the spring 118. The shaft 86 of the pin 86 proximate the tip 88 may include one or more circumferential or annular grooves in which the ball bearings 112 are at least partially seated when the latch mechanism 110 is in the gripping position.

The action of the latch mechanism 110 is such that, while the pin 84 may be able to be inserted further into the latch mechanism 110 in a first insertion direction, the gripping of the pin 84 by the ball bearings 112 prevents the pin 84 from being withdrawn from the latch mechanism 110 in a second withdrawing direction. Accordingly, the latch mechanism 110 retains the pin 84 in the second, engaged position.

To release the pin 84 from the latch mechanism 110, a magnetic field is preferably applied to the latch mechanism 110. In preferred embodiments the latch housing 104 is positioned adjacent or in contact with a suitable magnet. The magnet is preferably positioned adjacent or in contact with the end wall 108 of the housing 104. The magnetic force acts to pull the metal actuating element 116 in a direction towards the end wall 108 and the spheres 112 are pulled, by the actuating element 116, into a part of the cup element 114 having a larger diameter. The grip of the spheres 112 on the pin 84 is therefore reduced, releasing the pin 84 from the latch mechanism 110. The spring 126 in the pin housing 96 acts to draw the tip 88 of the pin 84 out of the latch housing 104 and back into the pin housing 96 so that the pin 84 returns to the first position.

The security assembly 30 is designed to be releasably attached to an article or product in a retail store. The security assembly 30 preferably includes an electronic article surveillance (EAS) sensor 128 that generates detectable signals. A suitable EAS detector (not shown) is typically located at the exit (and entrance) of the retail store. If an article with a security assembly 30 attached is removed from the store and, therefore, passes the detector, the detector detects signals emitted by the EAS sensor 128 and triggers an alarm. To allow an article to leave the store without triggering the alarm, for example after purchase of the article, the security assembly 30 is detached from the article. Typically the security assembly 30 is detached at the point of sale of the article by a suitable detacher system (not shown).

In this embodiment the EAS sensor 128 is housed within the casing 76 of the first part 72 of the lockable security element 70. The EAS sensor 128 is therefore disposed between a part of the casing 76 and the rear panel 40 of the housing 32. In a preferred embodiment, and as illustrated most clearly in FIG. 15, the security assembly 30 comprises two EAS sensors 128, each one being housed in the casing 76. In this embodiment the EAS sensors are disposed on opposite sides of the latch assembly 78 and, in particular, each EAS sensor 128 is disposed between the latch assembly 78 and a respective nearest side edge 60 of the rear panel 40.

One or both of the EAS sensors 128 may be an acousto-magnetic (AM) sensor. In particular, each of the sensors 128 may comprise a ferrimagnetic or ferromagnetic amorphous metal strip having magnetostrictive properties. Preferably the amorphous metal strip is a ferrite. The amorphous metal strip may have a resonant frequency of about 58 KHz. Alternatively, one or both of the EAS sensors 128 may be a radio frequency (RF) sensor. The RF sensor may operate at about 8.2 MHz. In some embodiments one of the EAS sensors 128 may be an AM sensor and the other EAS sensor 128 may be a radio frequency (RF) sensor. In preferred embodiments each of the sensors 128 comprises an elongate strip of amorphous metal having a longitudinal axis, surrounded by a coil.

Referring now to FIG. 19, to secure the security assembly 30 to a hang tab box 10 the second part 74 of the lockable security element 70 is initially moved into the open position. The hang tab box 10 is seated in the housing 32 so that the bottom panel of the box 12 is adjacent or proximate the base panel 34 of the housing 32 and the header 14 is adjacent to the upper portion of the rear panel 40 of the housing 32. The box 12 may be seated so that the bottom panel is in contact with an upper surface of the base panel 34. A distance between the side panels 36, i.e. a width of the rear panel 40, is slightly larger than the width of the header 14 of the hang tab box 10 so that a distance between each of the side panels 18 of the box 12 and a respective side panel 36 of the housing 32 is minimised. This prevents access to the side panels 18 of the box 12. In this embodiment the height of the header 14 is such that the upper edge 22 of the header 14 does not extend above the upper edge 58 of the rear panel 40.

The second part 74 of the lockable security element 70 is then moved into the closed position such that a part of the header 14 is disposed in the gap between the clamping plate 80 and the rear panel 40.

The lockable security element 70 is then moved from the released configuration to the locked configuration. As the pin 84 protrudes from the clamping plate 80 the pin 84 extends through the header 14 of the hang tab box 10. In embodiments in which the header 14 of the hang tab box 10 includes an aperture or hang hole (e.g. a Euro hole, a delta hole, a circular hole, or the like) the pin 84 may extend through the hang hole. In other embodiments the tip 88 of the pin 84 may pierce a part of the header 14 as the pin 84 moves from the released configuration to the locked configuration.

With the lockable security element 70 in the locked configuration the hang tab box 10 is secured to the housing 32 so that the housing 32 at least partially surrounds the box 12. Furthermore, the second part 74 of the lockable security element 70 extends over the top panel 16 of the box 12. In the second position and locked configuration the second part 74 of the lockable security element 70 preferably restricts access to the top panel 16 of the box 12. The housing 32 and the lockable security element 70 therefore restrict access to the box 12 and prevent or deter a person from opening the box 12 to remove the contents of the box 12.

The gap between the opposing inner edges 54 of the front panel 38 allows a customer to clearly see the information, branding and other printed matter displayed on the front panel 20 of the box 12. Similarly, the gap between the opposing inner edges 62 of the rear panel 40 allows a customer to clearly see the information, branding and other printed matter displayed on the rear panel of the box 12. The security assembly 30 does not therefore obscure the majority of the surface of each of the primary front and rear panels of the hang tab box 10, such that these are still clearly visible to a customer in a retail display.

In preferred embodiments, such as that illustrated, the rear panel 40 includes a hang hole 129 proximate the upper edge 58. This allows the security assembly 30 to be suspended in a retail display in a similar manner to the hang tab box 10. In other embodiments the rear panel 40 and/or the lockable security element 70 are shaped such that when a hang tab box 10 is seated in and secured to the housing 32, the hang hole of the hang tab box 10 is exposed. In these embodiments, therefore, the hang tab box 10 may still be suspended in a retail display by the hang hole with the security assembly 30 attached.

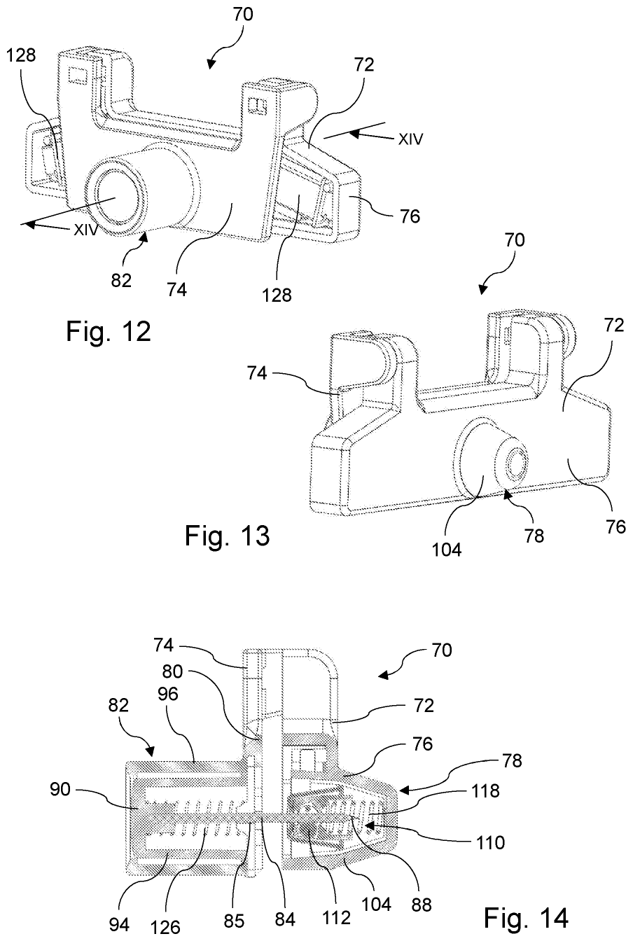

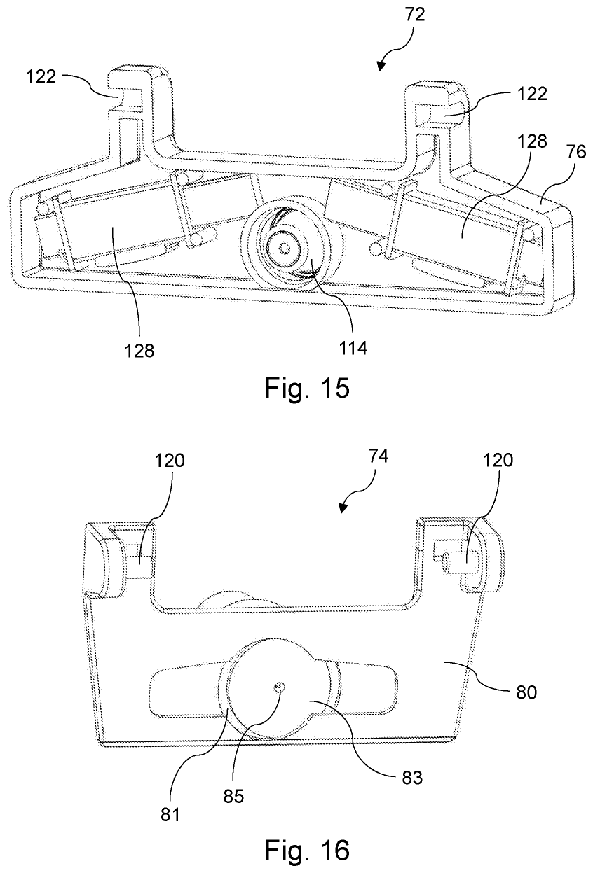

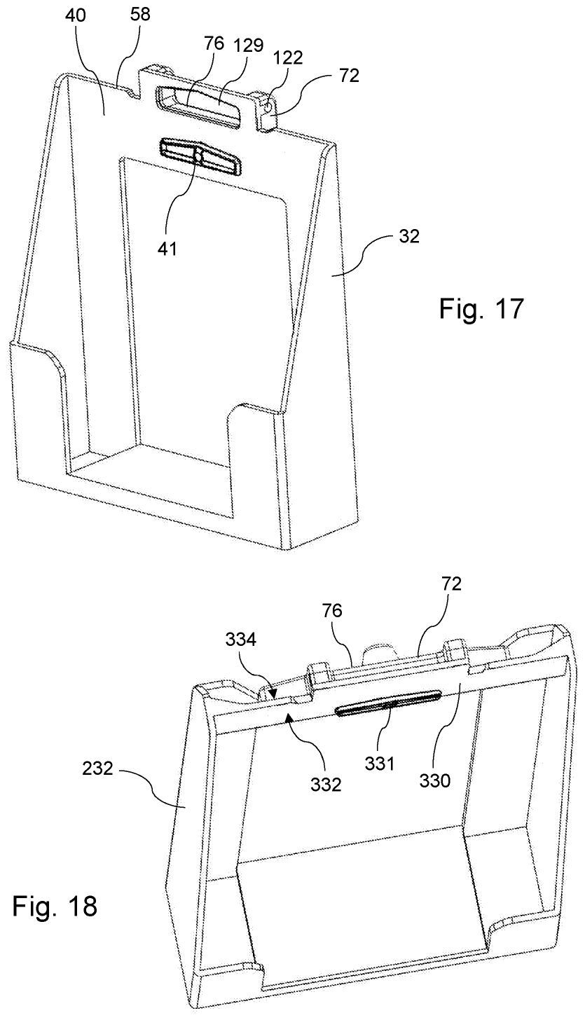

A second embodiment of a security assembly 230 according to the invention is shown in FIGS. 5 to 8. The security assembly 30 of the first embodiment was configured to be secured to a hang tab box 10 having a header 14 that was continuous with or aligned with the rear panel of the box 12. The security assembly 230 of this second embodiment is configured to be secured to a hang tab box 210 in which the header 214 extends from a central portion of the top panel 216 of the box 212, such that the header 214 is not aligned with or continuous with either of the rear or front panels 220 of the box 212, as illustrated in FIG. 20.

In this embodiment the security assembly 230 comprises a housing 232 and a lockable security element 70.

The housing 232 comprises a base panel 234, two side panels 236, a front panel 238 and a rear panel 240. In this embodiment the arrangement and shape of the base panel 234, front panel 238 and side panels 236 is substantially the same as the corresponding base panel 34, front panel 38 and side panels 36 of the first embodiment of the housing 32, and will not be described further in relation to this embodiment.

The rear panel 240 comprises two lateral portions that each extend upwardly from a lower edge 256. In some embodiments a central portion may extend between the lateral portions adjacent the lower edge, but in this embodiment this central portion is omitted. Each of the lateral portions has an inner edge 262, and there is a gap between the opposing inner edges 262. In preferred embodiments the distance between the inner edges 262 of the rear panel 240 is the same as a distance between inner edges 254 of the front panel 238.

In this example, a maximum distance between a lower edge 248 and an upper edge 250 of the front panel 238, i.e. a height of the front panel 238, is less than a maximum distance between the lower edge 256 and an upper edge 258 of the rear panel 240, i.e. a height of the rear panel 240. In this example the maximum height of the rear panel 240 is more than five times the maximum height of the front panel 238.

Each of the side panels 236, together with the respective lateral portion of the front panel 238 and lateral portion of the rear panel 240 extending from the side panel 236, forms a lateral guard portion 268 of the housing 232.

In this embodiment the housing 232 further comprises a rail 330 that extends between the side panels 236 in an upper region of the side panels 236. The rail 330 has opposite front and rear surfaces 332, 334, the front surface 332 facing in a direction generally towards a first plane containing the front panel 238 of the housing 232 and the rear surface 334 facing in a direction generally towards a second plane containing the rear panel 240 of the housing 232. A plane containing the rail 330 is therefore disposed between the first and second planes, and extends parallel to each of the first and second planes, i.e. the rail 330 extends parallel to each of the front and rear panels 238, 240.

In this embodiment, the lockable security element 70 is attached to the rail 330. The lockable security element 70 comprises a first part 72 secured to the housing 232 in a fixed position and a second part 74 that is moveable with respect to the first part 72. In preferred embodiments the first part 72 of the lockable security element 70 is permanently secured to the housing 232. The lockable security element 70 of this embodiment is identical to the lockable security element 70 of the first embodiment and will not be described further.

FIG. 18 shows the first part 72 of the lockable security element 70 attached to the rail 330 of the housing 232 of this embodiment. The casing 76 of the first part 72 of the lockable security element 70 is secured to the rear surface 334 of the rail 330 in a central region of the rail 330. The rail 330 includes an aperture or hole 331 which is aligned with the latch assembly 78 housed within the first part 72.

The security assembly 230 preferably includes an electronic article surveillance (EAS) sensor 128 that generates detectable signals. In an identical manner to the first embodiment, the EAS sensors 128 of this embodiment are housed within the casing 76 of the first part 72 of the lockable security element 70. The EAS sensors 128 are therefore disposed between a part of the casing 76 and the rail 330 of the housing 232.

Referring now to FIG. 20, to secure the security assembly 230 to a hang tab box 210 the second part 74 of the lockable security element 70 is initially moved into the open position. The hang tab box 210 is seated in the housing 232 so that the bottom panel of the box 212 is adjacent or proximate the base panel 234 of the housing 232 and the header 214 is adjacent to the rail 330 of the housing 232. The second part 74 of the lockable security element 70 is then moved into the closed position such that a part of the header 214 is disposed in a gap between the clamping plate 80 and the front surface 332 of the rail 330.

The lockable security element 70 is then moved from the released configuration to the locked configuration. As the pin 84 protrudes from the clamping plate 80 the pin 84 extends through the header 214 of the hang tab box 210. In embodiments in which the header 214 of the hang tab box 210 includes an aperture or hang hole (e.g. a Euro hole, a delta hole, a circular hole, or the like) the pin 84 may extend through the hang hole. In other embodiments the tip 88 of the pin 84 may pierce a part of the header 214 as the pin 84 moves from the released configuration to the locked configuration.

With the lockable security element 70 in the locked configuration the hang tab box 210 is secured to the housing 232 so that the housing 232 at least partially surrounds the box 212. The housing 232 therefore restricts access to the box 212 and prevents or deters a person from opening the box 212 to remove the contents of the box 212.

As in the first embodiment, the gap between the opposing inner edges 254 of the front panel 238 allows a customer to clearly see the information, branding and other printed matter displayed on the front panel 220 of the box 212. Similarly, the gap between the opposing inner edges 262 of the rear panel 240 allows a customer to clearly see the information, branding and other printed matter displayed on the rear panel of the box 212. The security assembly 230 does not therefore obscure the majority of the surface of each of the primary front and rear panels of the hang tab box 210, such that these are still clearly visible to a customer in a retail display.

In preferred embodiments, such as that illustrated, the rail 330 includes a hang hole 329. This allows the security assembly 230 to be suspended in a retail display in a similar manner to the hang tab box 10. In other embodiments the rail 330 and/or the lockable security element 70 are shaped such that when a hang tab box 10 is seated in and secured to the housing 232, the hang hole of the hang tab box 10 is exposed.

In these embodiments, therefore, the hang tab box 10 may still be suspended in a retail display by the hang hole with the security assembly 230 attached.

Although in the above embodiments the first part 72 of the lockable security element 70 is permanently secured to the housing 32, 232, in other embodiments the first part 72 of the lockable security element 70 may be releasably secured to the housing. Th lockable security element 70 may be secured to the housing by means of mechanical connectors such as clips, inter-engaging features, or the like. In some embodiments the first part 72 may be engageable with the housing 32 to retain the first part 72 in a fixed position relative to the housing 32. Moving the second part 74 into a locked configuration, as described above, may, in addition to securing the housing to the hang tab box, also lock the first part 72 to the housing 32.

In the above embodiments the EAS sensors 128 are housed in the first part 72 of the lockable security element 70. In other embodiments the EAS sensor or EAS sensors may be housed in the second part 74 of the lockable security element 70 or the EAS sensor(s) may be retained on or in a part of the housing.

The first and second parts 72, 74 of the lockable security element 70 are preferably hingedly connected to each other, as described above. In other embodiments the first and second parts 72, 74 may be otherwise moveably connected together. The first and second parts may, for example, be slidably connected together.

The housing 32, 232 of the security assembly 30, 230 of the present invention is preferably made from a suitable rigid polymeric material. The housing 32, 232 is preferably made from a transparent or translucent polymeric material.

The casing 76 of the first part 72 of the lockable security element 70 is preferably made of a suitable rigid or hard polymeric material. Similarly, the button assembly and pin housing 96 of the second part 74 of the lockable security element 70 are also preferably made of a suitable rigid or hard polymeric material.

Other modifications and variations not explicitly disclosed above may also be contemplated without departing from the scope of the invention as defined in the appended claims.

1. A security assembly comprising:
a housing including a base panel, a front panel, a rear panel and two side panels, each side panel extending between the front panel and the rear panel, the housing defining a space for receiving an item, and edges of the front panel, rear panel and two side panels defining an opening of the housing;
a lockable security element having a first part comprising a latch mechanism and a second part comprising a pin having a tip, in use, a part of said item being clamped between the first and second parts of the lockable security element; and
an EAS sensor,
wherein, the pin is moveable from a first position in which the tip of the pin is within the second part to a second position in which the pin extends from the second part into the first part so as to, in use, extend through a portion of said item clamped between the first and second parts, and the latch mechanism being configured to releasably retain the tip of the pin when the pin is in the second position, and
wherein a part of the housing is disposed between the first and second parts of the lockable security element, said part of the housing including a hole aligned with the latch mechanism through which the pin extends when the pin is in the second position.

2. The security assembly according to claim 1, in which the first part of the security element is secured to the housing in a fixed position relative to the housing and adjacent the opening of the housing, and the second part of the security element is moveable relative to the first part between an open position, in which an item is insertable into the housing, and a closed position, in which the second part obstructs the opening and, wherein, in the closed position the pin is moveable from the first position to the second position.

3. The security assembly according to claim 1, in which the first part of the lockable security element is permanently secured to the housing.

4. The security assembly according to claim 1, in which the first part of the lockable security element is secured to the rear panel of the housing.

5. The security assembly according to claim 4, in which the first part of the lockable security element is secured to a surface of the rear panel such that a part of the rear panel is disposed between the first and second parts of the lockable security element.

6. The security assembly according to claim 1, in which the housing comprises a rail extending between the side panels, and in which the first part of the lockable security element is secured to the rail.

7. The security assembly according to claim 6, in which the first part of the lockable security element is secured to a surface of the rail such that a part of the rail is disposed between the first and second parts of the lockable security element.

8. The security assembly according to claim 1, in which the first and second parts of the lockable security element are hingedly connected.

9. The security assembly according to claim 1, in which the latch mechanism is magnetically releasable.

10. The security assembly according to claim 1, in which the EAS sensor is housed in the first part of the lockable security element.

11. The security assembly according to claim 1, further comprising a second EAS sensor, and in which the EAS sensors are disposed in the first part of the lockable security element.

12. The security assembly according to claim 1, in which the rear panel comprises a first lateral portion and a second lateral portion and there is a gap between the first and second lateral portions defined by a distance between inner edges of the lateral portions.

13. The security assembly according to claim 1, in which the front panel comprises a first lateral portion and a second lateral portion and there is a gap between the first and second lateral portions defined by a distance between inner edges of the lateral portions.

14. The security assembly according to claim 1, in which the housing is made of a transparent or translucent polymeric material.

15. An assembly comprising:
a security assembly according to claim 1; and
a hang tab box seated in the housing of the security assembly, a header of the hang tab box disposed between the first and second parts of the lockable security element.

16. An assembly comprising:
a housing including a base panel, a front panel, a rear panel and two side panels, each side panel extending between the front panel and the rear panel, and the rear panel including a hole;
a hang tab box seated in the housing with a header of the hang tab box disposed adjacent the rear panel of the housing;
a lockable security element having a first part comprising a latch mechanism and a second part comprising a pin having a tip, the header of the hang tab box and the rear panel of the housing disposed between the first and second parts of the lockable security element, the pin extending through the header and the hole in the rear panel, and the latch mechanism releasably retaining the tip of the pin; and
an EAS sensor.

17. A method of securing a security assembly to a hang tab box, the security assembly being according to claim 1, and the method comprising:
seating the hang tab box in the housing of the security assembly; and
moving the pin from the first position into the second position so that the pin extends through the header and the hole of the housing and is engaged in the latch mechanism.

18. The method according to claim 17, the method further comprising:
seating the hang tab box in the housing with the second part of the lockable security element in the open position; and
moving the second part of the lockable security element into the closed position so that a part of a header of the hang tab box is disposed between the first and second parts of the lockable security element before moving the pin from the first position into the second position.

19. The method according to claim 18, in which the hang tab box is seated in the housing such that the header is disposed adjacent the rear panel of the housing, and the second part of the lockable security element is moved into the closed position so that a part of the header and a part of the rear panel are clamped between the first and second parts of the lockable security element.

20. The method according to claim 18, in which the housing comprises a rail extending between the side panels and in which the hang tab box is seated in the housing such that the header is disposed adjacent the rail, and in which the second part of the lockable security element is moved into the closed position so that a part of the header and a part of the rail are clamped between the first and second parts of the lockable security element.
